(19) United States
(12) Patent Application Publication
(10) Pub. No.: US 2018/0056199 A1
(43) Pub. Date: Mar. 1, 2018

(54) THREE-DIMENSIONAL OBJECT

(71) Applicant: MIMAKI ENGINEERING CO., LTD., Nagano (JP)

(72) Inventors: Keita Nishio, Nagano (JP); Masakatsu Okawa, Nagano (JP); Yoshihiro Tanaka, Nagano (JP)

(73) Assignee: MIMAKI ENGINEERING CO., LTD., Nagano (JP)

(21) Appl. No.: 15/688,880

(22) Filed: Aug. 29, 2017

(30) Foreign Application Priority Data
Aug. 29, 2016 (JP) 2016-166964

(51) Int. Cl. A63H 9/00; G09B 23/34; A41G 3/00; B33Y 80/00

(52) U.S. Cl. CPC A63H 9/00; B33Y 80/00; A41G 3/0008; G09B 23/34

(57) ABSTRACT

A three-dimensional object configured by a plurality of divided parts and having a surface, one portion of the surface is covered with a covering member. The three-dimensional object includes a first divided part as the divided part, which at least one portion of the first divided part is exposed from the covering member; and a second divided part as the divided part and is covered with the covering member. In the three-dimensional object, at least one portion of a joining surface of the first divided part and the second divided part is covered with the covering member.

### CROSS REFERENCE TO RELATED APPLICATIONS

This application claims the priority benefit of Japanese Patent Application No. 2016-166964, filed on Aug. 29, 2016. The entirety of the above-mentioned patent application is hereby incorporated by reference herein and made a part of this specification.

### TECHNICAL FIELD

The present disclosure relates to a three-dimensional object configured by a plurality of divided parts.

### DESCRIPTION OF THE BACKGROUND ART

A method for manufacturing a large three-dimensional object is conventionally known (see e.g., Japanese Unexamined Patent Publication No. 2009-83491). In the method for manufacturing the three-dimensional object described in Japanese Unexamined Patent Publication No. 2009-83491, a plurality of divided parts configuring the three-dimensional object are created, and thereafter, the plurality of created divided parts are joined to manufacture the large three-dimensional object.

Patent Literature 1: Japanese Unexamined Patent Publication No. 2009-83491

### SUMMARY

In the case of the three-dimensional object configured by a plurality of divided parts, the appearance of the three-dimensional object becomes poor if the joining portion of the divided parts stands out. Thus, it is preferable that the joining portion of the divided parts be not easily noticeable in the three-dimensional object configured by the plurality of divided parts.

The present disclosure provides a three-dimensional object configured by a plurality of divided parts, where the joining portion of the divided parts is not easily noticeable.

To solve the problem described above, a three-dimensional object of the present disclosure relates to a three-dimensional object configured by a plurality of divided parts and having a surface, one portion of the surface is covered with a covering member; the three-dimensional object includes: a first divided part as the divided part, at least one portion of the first divided part is exposed from the covering member; and at least one second divided part as the divided part and is covered with the covering member. At least one portion of a joining surface of the first divided part and the second divided part is covered with the covering member.

In the three-dimensional object of the present disclosure, at least one portion of the joining surface is covered with the covering member, wherein the joining surface is between the first divided part in which at least one portion is exposed from the covering member and the second divided part covered with the covering member. In other words, in the present disclosure, at least one portion of the joining portion of the first divided part and the second divided part is covered with the covering member. Thus, in the present disclosure, the joining portion of the first divided part and the second divided part can be prevented from being easily noticed. In other words, in the present disclosure, the joining portion of the divided parts can be prevented from being easily noticed.

In the present disclosure, entire of the joining surface is preferably covered with the covering member. According to such configuration, the entire joining portion of the first divided part and the second divided part is covered with the covering member, and hence the joining portion of the first divided part and the second divided part cannot be seen from the outside. Therefore, the joining portion of the first divided part and the second divided part is not easily noticeable.

In the present disclosure, for example, the first divided part is a 3D object of a face of a human, the second divided part is a 3D object of a back of a head of the human, and the covering member is wig. In other words, the three-dimensional object of the present disclosure is, for example, a 3D object of a head region of a human. In such a case, even if the 3D object of the head region of a human is configured by a plurality of divided parts, the jointing portion of the divided parts can be prevented from being easily noticeable.

Therefore, in the present disclosure, the joining portion of the divided parts can be prevented from being easily noticeable in the three-dimensional object configured by a plurality of divided parts.

### BRIEF DESCRIPTION OF THE DRAWINGS

FIG. 1 is a side view of a three-dimensional object according to an embodiment of the present disclosure.

FIG. 2 is a side view of a state in which the three-dimensional object shown in FIG. 1 is disassembled.

FIG. 3 is a rear view of a sate in which the divided parts are joined according to another embodiment of the present disclosure.

FIG. 4 is a rear view of a state in which the divided parts are disassembled according to another embodiment of the present disclosure.

FIG. 5 is a rear view of the three-dimensional object according to a reference mode 1 of the present disclosure.

FIG. 6 is a side view of a state in which the three-dimensional object shown in FIG. 5 is disassembled.

FIG. 7 is a front view of a three-dimensional object according to a reference mode 2 of the present disclosure.

FIG. 8 is a block diagram of a three-dimensional object manufacturing system for manufacturing the divided parts and the like shown in FIG. 1.

FIG. 9 is a view for describing one example of a method for determining a dividing plane of the three-dimensional object in a higher-level device shown in FIG. 8.

FIG. 10 is a flowchart for describing one example of a method for determining the dividing plane of the three-dimensional object in the higher-level device shown in FIG. 8.

FIG. 11 is a flowchart for describing one example of a method for determining the dividing plane of the three-dimensional object in the higher-level device shown in FIG. 8.

FIG. 12 is a view for describing one example of a method for determining the dividing plane of the three-dimensional object in the higher-level device shown in FIG. 8.

FIG. 13 is a view for describing one example of a method for determining a dividing plane of the three-dimensional object in the higher-level device shown in FIG. 8.

FIG. 14 is a flowchart for describing one example of a method for determining the dividing plane of the three-dimensional object in the higher-level device shown in FIG. 8.

### DETAILED DESCRIPTION OF EMBODIMENTS

Hereinafter, an embodiment of the present disclosure will be described with reference to the drawings.

(Configuration of Three-Dimensional Object)

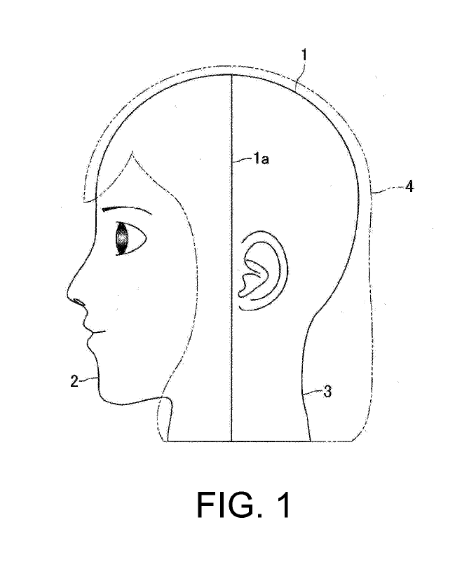

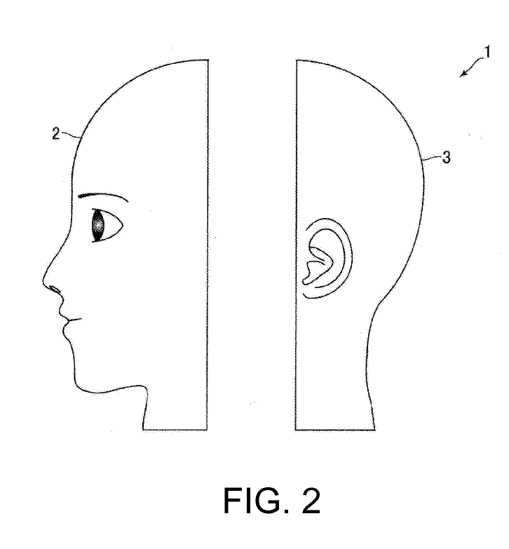

FIG. 1 is a side view of a three-dimensional object 1 according to an embodiment of the present disclosure. FIG. 2 is a side view of a state in which the three-dimensional object 1 shown in FIG. 1 is disassembled.

The three-dimensional object 1 of the present embodiment is a 3D object of a head region of a human. The three-dimensional object 1 is configured by a plurality of divided parts 2, 3. Specifically, the three-dimensional object 1 is configured by a two divided parts 2, 3. The divided part 2 is a 3D object of a face of a human, and the divided part 3 is a 3D object of a back of the head of the human. In other words, the three-dimensional object 1, which is the 3D object of the head region of the human, is divided in half at a plane orthogonal to a front and back direction of the head region so as to be configured by the divided part 2 and the divided part 3. In the present embodiment, the three-dimensional object 1 is divided in half at substantially a center position in the front and back direction of the head region.

One portion of the surface of the three-dimensional object 1 is covered with a wig 4 serving as a covering member. One portion (portion of eyes, nose, mouth, etc.) of the divided part 2 is not covered with the wig 4, and is exposed from the wig 4. The divided part 3 is covered with the wig 4. Specifically, the entire divided part 3 is covered with the wig 4. The divided part 2 and the divided part 3 are joined to each other by adhesive, for example.

A joint surface 1a of the divided part 2 and the divided part 3 is covered with the wig 4. Specifically, the entire joint surface 1a is covered with the wig 4. The divided part 2 of the present embodiment is a first divided part, and the divided part 3 is a second divided part. The divided parts 2, 3 are shaped by layering an ink layer formed by an ink discharged from an inkjet head (not shown) on a table (not illustrated), and are formed with a model material (resin).

(Main Effects of Present Embodiment)

As described above, in the present embodiment, the joint surface 1a of the divided part 2 and the divided part 3 is covered with the wig 4. Thus, in the present embodiment, the joining portion of the divided part 2 and the divided part 3 can be prevented from being easily noticed. In particular, in the present embodiment, the joining portion of the divided part 2 and the divided part 3 cannot be seen from the outside as the entire joint surface 1a is covered with the wig 4. Therefore, in the present embodiment, the joining portion of the divided part 2 and the divided part 3 is not easily noticed.

(Other Embodiments)

In the embodiment described above, the entire joint surface 1a is covered with the wig 4, but one portion of the joint surface 1a may not be covered with the wig 4. In this case as well, the joint surface 1a cannot be seen when the three-dimensional object 1 is seen from the front (i.e., front of the divided part 2 being the 3D object of the face of the human) of the three-dimensional object 1, which is the 3D object of the head region of the human. Thus, even in such a case, the joining portion of the divided part 2 and the divided part 3 cannot be easily noticed.

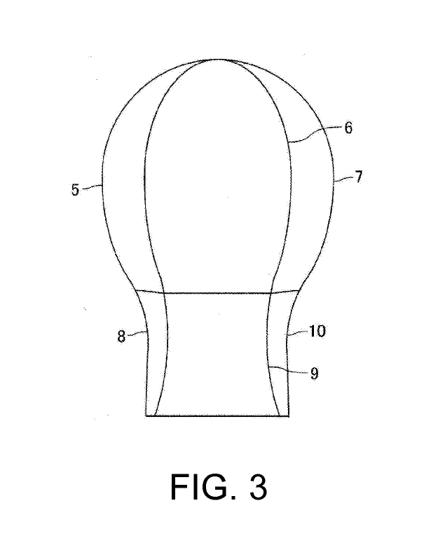

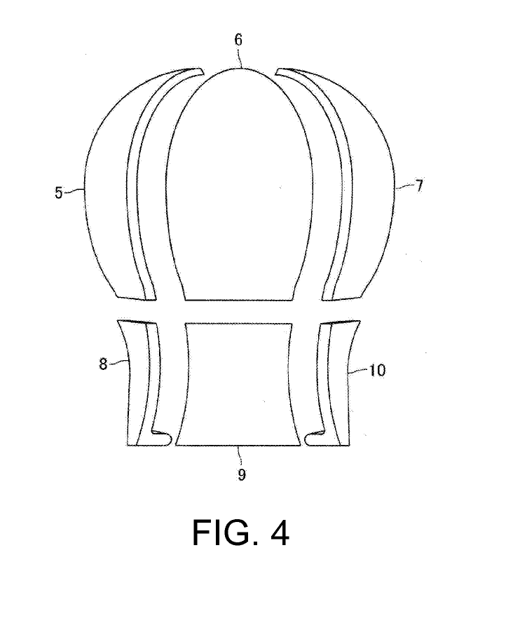

In the embodiment described above, the 3D object of the back of the head is configured by one divided part 3, but the 3D object of the back of the head may be configured by a plurality of divided parts 5 to 10, as shown in FIGS. 3 and 4. For example, the 3D object of the back of the head may be configured by six divided parts 5 to 10. In this case, the joining portion of the divided parts 5 to 10 is covered with the wig 4, and thus the joining portion of the divided parts 5 to 10 is not easily noticeable even if the 3D object of the back of the head is configured by the plurality of divided parts 5 to 10. The divided parts 5 to 10 in this case are the second divided parts.

In the embodiment described above, the three-dimensional object 1 is a 3D object of the head region of the human, but the three-dimensional object, to which the present disclosure is applied, may be a 3D object other than the head region of the human.

(Reference Mode 1 of Three-Dimensional object)

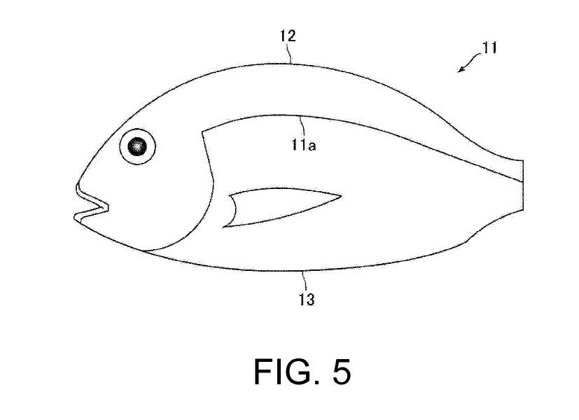

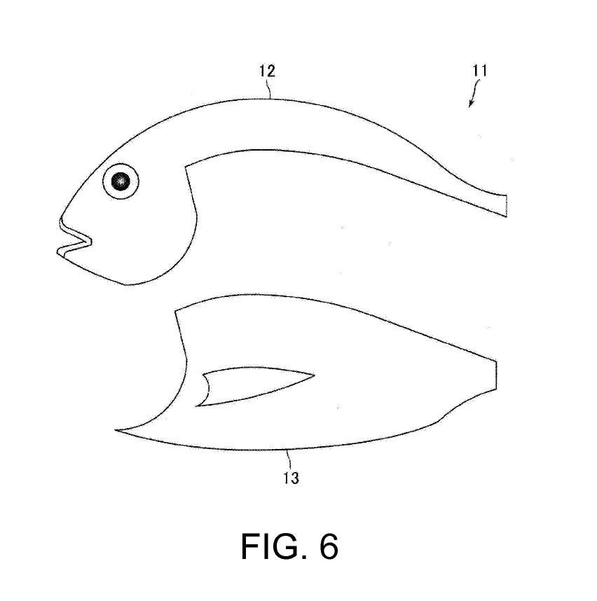

FIG. 5 is a side view of a three-dimensional object 11 according to a reference mode 1 of the present disclosure. FIG. 6 is a side view of a state in which the three-dimensional object 11 shown in FIG. 5 is disassembled.

The three-dimensional object 11 according to the reference mode 1 is a 3D object of a head region and a body portion of a fish. Specifically, the three-dimensional object 11 is a 3D object of a head region and a body portion of a sea bream. The three-dimensional object 11 is configured by two divided parts 12, 13. The divided part 12 is a 3D object of the head region and a back portion of the sea bream, and the divided part 13 is a 3D object of a belly portion of the sea bream. The divided parts 12, 13 are shaped by layering an ink layer formed by an ink discharged from an inkjet head (not shown) on a table (not illustrated), and are formed with a model material (resin).

In the real sea bream, a boundary of the belly portion and the back portion is formed to a curved depression, a boundary of a gill cover and the belly portion is also formed to a depression, and the depressions are connected to each other. In the three-dimensional object 11 as well, a boundary of the belly portion and the back portion of the sea bream is formed to a curved depression, a boundary of a gill cover and the belly portion of the sea bream is also formed to a depression, and the depressions are connected to each other. The three-dimensional object 11 of the present mode is divided in half at a plane along the depression, and thus is configured by the divided part 12 and the divided part 13. In other words, in the three-dimensional object 11, the divided part 12 and the divided part 13 are joined at the joining surface 11a that lies along the depression. The divided part 12 and the divided part 13 are joined to each other by adhesive, for example.

In the three-dimensional object 11 according to the reference mode 1, the divided part 12 and the divided part 13 are joined at the joining surface 11a that lies along the depression, and hence the joining portion of the divided part 12 and the divided part 13 is not easily noticeable.

(Reference Mode 2 of Three-Dimensional Object)

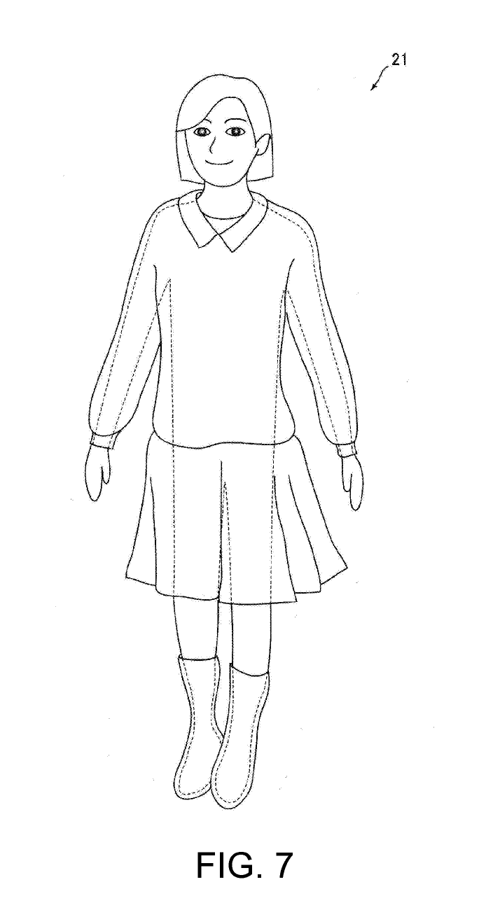

FIG. 7 is a front view of a three-dimensional object 21 according to a reference mode 2 of the present disclosure.

The three-dimensional object 21 according to the reference mode 2 is a full size figure, and is wearing clothes. In the three-dimensional object 21, the portion exposed from the clothes is shaped by layering an ink layer formed by an ink discharged from an inkjet head (not shown) on a table (not illustrated), and is formed with a model material (resin). The portion covered with the clothes (portion indicated with broken line in FIG. 7), on the other hand, is configured by a general purpose component such as one portion of a mannequin or a component manufactured using a die. The portion formed with the model material and the general purpose component are, for example, coupled with a screw.

In the three-dimensional object 21 according to the reference mode 2, the portion exposed from the clothes is formed with the model material, and the portion covered with the clothes is formed with the general purpose component, and hence the cost of the three-dimensional object 21 can be reduced while maintaining a realistic feeling of the three-dimensional object 21, which is a full size figure.

(Configuration of Three-Dimensional Object Manufacturing System)

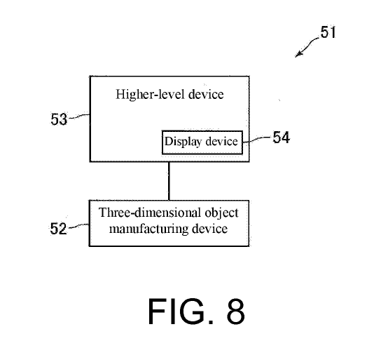

FIG. 8 is a block diagram of a three-dimensional object manufacturing system 51 for manufacturing the divided parts 2, 3 and the like shown in FIG. 1.

The divided parts 2, 3, 5 to 10, 12, and 13 are shaped with the three-dimensional object manufacturing system 51. The three-dimensional object manufacturing system 51 includes a three-dimensional object manufacturing device 52 and a higher-level device 53. The three-dimensional object manufacturing device 52 includes an inkjet head, a carriage (not illustrated) on which the inkjet head is mounted, a table, and a raising/lowering mechanism (not illustrated) of the table, and the like. The higher-level device 53 is, for example, a personal computer (PC), and includes a display device 54 such as a liquid crystal display device.

For example, when shaping the divided parts 2, 3, the higher-level device 53 first creates three-dimensional data corresponding to the three-dimensional object 1. Specifically, the higher-level device 53 creates the three-dimensional data corresponding to the three-dimensional object 1 based on a detection result of the shape of a shaping target object by a three-dimensional scanner (not illustrated). The three-dimensional data is surface data including only information on the surface of the three-dimensional object 1. Specifically, the three-dimensional data is a polygon model in which the surface of the three-dimensional object 1 is represented with a set of a great number of triangles.

Thereafter, the higher-level device 53 divides the three-dimensional data, and creates divided three-dimensional data corresponding to the divided parts 2, 3. In other words, the higher-level device 53 determines a dividing surface of the three-dimensional object 1, and creates the divided three-dimensional data corresponding to the divided parts 2, 3. After the divided three-dimensional data is created, the divided three-dimensional data is transmitted from the higher-level device to the three-dimensional object manufacturing device 52, so that the three-dimensional object manufacturing device 52 layers the ink layer on the table based on the divided three-dimensional data to shape the divided parts 2, 3.

(Reference Example 1 of Method For Determining Dividing Plane of Three-Dimensional Object)

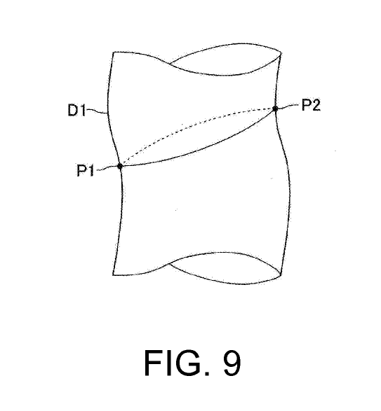

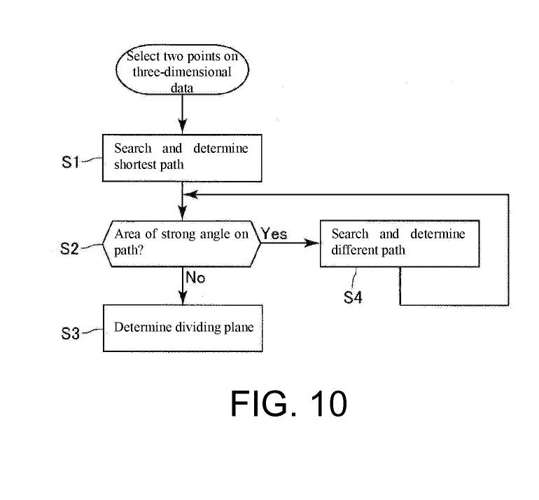

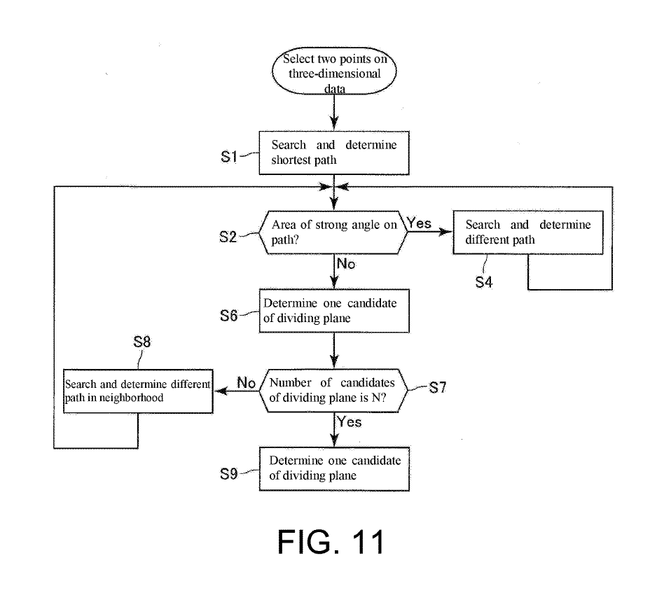

FIG. 9 is a view describing one example of a method for determining a dividing plane of the three-dimensional object in the higher-level device 53 shown in FIG. 8. FIG. 10 is a flowchart for describing one example of a method for determining the dividing plane of the three-dimensional object in the higher-level device 53 shown in FIG. 8. FIG. 11 is a flowchart for describing one example of a method for determining the dividing plane of the three-dimensional object in the higher-level device 53 shown in FIG. 8.

The higher-level device 53 determines the dividing plane of the three-dimensional object in, for example, the following manner. In other words, in three-dimensional data D1 (see FIG. 9) displayed on the display device 54, when the user selects predetermined two points P1, P2 (see FIG. 9) on the three-dimensional data D1, the higher-level device 53 searches and determines a shortest path connecting the two points P1, P2 (step S1), as shown in FIG. 10. Thereafter, the higher-level device 53 determines whether or not an area of strong angle exists on the path determined in step S1 (step S2). In step S2, the higher-level device 53 determines whether or not an area of strong angle exists on the path determined in step S1 based on a triangular normal vector arranged on the path determined in step S1 out of the great number of triangles configuring the polygon model.

If, in step S2, the area of strong angle does not exist on the path determined in step S1, the higher-level device 53 determines the cross-section including the path determined in step S1 as the dividing plane of the three-dimensional object (step S3). After determining the dividing plane of the three-dimensional object in step S3, the higher-level device 53 divides the three-dimensional data D1 to create the divided three-dimensional data. If, in step S2, the area of strong angle exists on the path determined in step S1, the higher-level device 53 searches and determines another path different from the path determined in step S1 (step S4), and then returns to step S2. In step S2 after step S4, the higher-level device 53 determines whether or not an area of strong angle exists on the path determined in step S4.

In the method for determining the dividing plane of the three-dimensional object, the dividing plane of the three-dimensional object can be automatically determined while preventing a pointed portion from being formed in the divided part to be shaped. The dividing plane actually adopted as the dividing plane by the user may be selected from a plurality of candidates of the dividing plane of the three-dimensional object presented by the higher-level device 53. In this case, as shown in FIG. 11, if, in step S2, the area of strong angle does not exist on the path determined in step S1 or step S4, the higher-level device 53 determines the cross-section including the path determined in step S1 or step S4 as one candidate of the dividing plane of the three-dimensional object (step S6). Thereafter, the higher-level device 53 determines whether or not the number of candidates of the dividing plane is a predetermined number (N (N is an integer greater than or equal to two)) (step S7).

If the number of candidates of the dividing plane is smaller than N in step S7, the higher-level device 53 searches and determines a different path near the path determined in step S1 or step S4 (step S8), and thereafter, returns to step S2. In step S2 after step S8, the higher-level device 53 determines whether or not the area of strong angle exists on the path determined in step S8. On the other hand, if the number of candidates of the dividing plane is N in step S7, the higher-level device 53 determines the N dividing planes as the candidates of the dividing plane actually adopted as the dividing plane by the user (step S9). The user selects the dividing plane to actually adopt as the dividing plane from the plurality of candidates of the dividing plane determined in step S9.

(Reference Example 2 of Method For Determining Dividing Plane of Three-Dimensional Object)

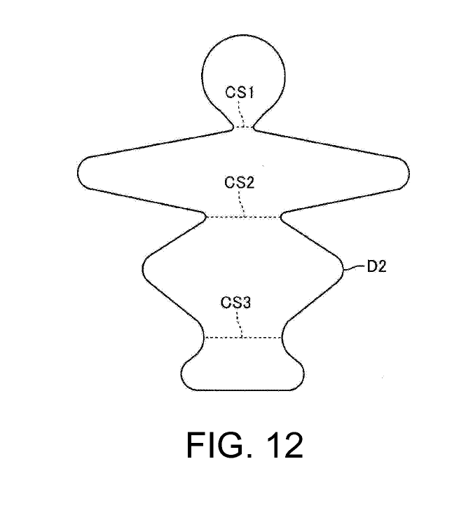

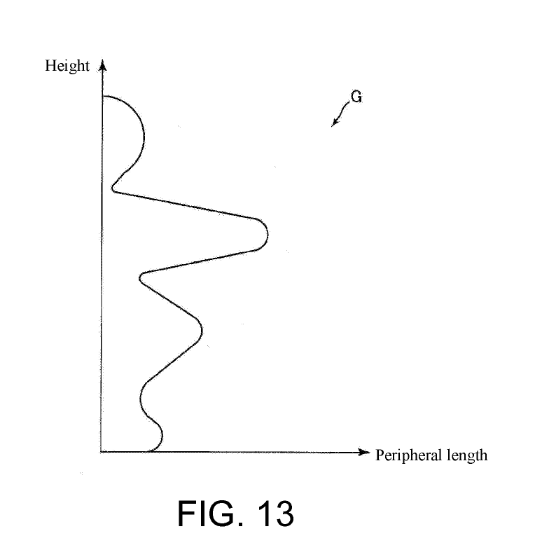

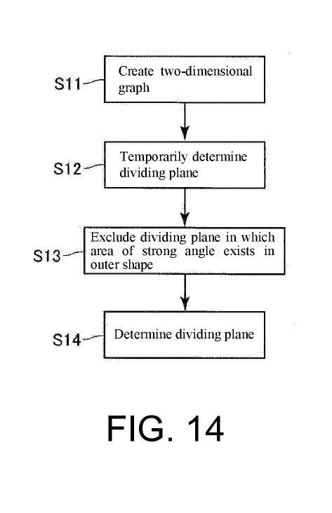

FIGS. 12 and 13 are views for describing one example of the method for determining the dividing plane of the three-dimensional object in the higher-level device 53 shown in FIG. 8. FIG. 14 is a flowchart for describing one example of the method for determining the dividing plane of the three-dimensional object in the higher-level device 53 shown in FIG. 8.

The higher-level device 53 may, for example, determine a layered surface of the ink layer as the dividing plane of the three-dimensional object. In this case, the higher-level device 53 first creates a two-dimensional graph G (see FIG. 13) showing a relationship of a height (height in the layering direction of the ink layer) of the three-dimensional data D2 (see FIG. 12) displayed on the display device 54, and a peripheral length of the three-dimensional data D2 at each height (step S11). Thereafter, the higher-level device 53 temporarily determines the dividing plane based on the two-dimensional graph G (step S12).

Specifically, in step S12, the higher-level device 53 temporarily determines a cross-section of an area in which the peripheral length of the three-dimensional data D2 is greater than or equal to a predetermined length L1 and smaller than or equal to a predetermined length L2 as the dividing plane. For example, the higher-level device 53 temporarily determines the cross-sections CS2, CS3 shown in FIG. 12 as the dividing plane in step S12. The cross-section CS1 shown in FIG. 12, for example, is not temporarily determined as the dividing plane in step S12 as the peripheral length of the area corresponding to the cross-section CS1 is smaller than a length L1.

Thereafter, the higher-level device 53 determines whether or not an area of strong angle exists in the respective outer shape of the cross-sections temporarily determined in step S12, excludes the cross-section with the area of strong angle in the outer shape from the dividing plane (step S13), and determines the dividing plane (step S14). In step S13, the higher-level device 53 determines whether or not the area of strong angle exists in the respective outer shape of the cross-section temporarily determined in step S12, based on the triangular normal vector included in each cross-section temporarily determined in step S12 out of the great number of triangles configuring the polygon model. Furthermore, in step S14, the higher-level device 53 determines, for example, two cross-sections CS2, CS3 as the dividing plane of the three-dimensional object.

In the method for determining the dividing plane of the three-dimensional object, the dividing plane of the three-dimensional object can be automatically determined while preventing a pointed portion from being formed in the divided part to be shaped. Furthermore, in the method for determining the dividing plane of the three-dimensional object, the cross-section of the area in which the peripheral length of the three-dimensional data D2 is smaller than or equal to a predetermined length L2 is temporarily determined as the dividing plane, and thus the possibility that the narrowed portion of the three-dimensional object becomes the joining portion of the divided parts becomes high. Therefore, the joining portion of the divided parts can be prevented from being easily noticed.

Furthermore, in the method for determining the dividing plane of the three-dimensional object, the cross-section of the area in which the peripheral length of the three-dimensional data D2 is smaller than the predetermined length L1 does not become the dividing plane, and thus the area of the joining surface of the divided parts can be ensured, and consequently, the joining strength of the divided parts joined with the adhesive can be ensured. Moreover, in the method for determining the dividing plane of the three-dimensional object, the layering surface of the ink layer is determined as the dividing plane of the three-dimensional object, and thus the dividing plane of the three-dimensional object can be easily determined in a short time.

(Reference Example 3 of Method For Determining Dividing Plane of Three-Dimensional Object)

The cross-section including the area where the color of the three-dimensional object is suddenly changed, and the cross-section including the area where the angle of the three-dimensional object is suddenly changed may be determined as the dividing plane of the three-dimensional object. In this case, for example, the higher-level device 53 draws a line in some portions to become the candidates of the dividing plane of the three-dimensional object of the three-dimensional data displayed on the display device 54. The user determines the dividing plane of the three-dimensional object from the shown candidates.

(Reference Example 4 of Method For Determining Dividing Plane of Three-Dimensional Object)

For example, in manufacturing of a figure (three-dimensional object) of an animation character, the higher-level device 53 may determine the dividing plane of the three-dimensional object using a rig (framework) set at the time of creating the animation. Specifically, the higher-level device 53 may detect a joint of the rig and determine the cross-section including the joint as the dividing plane of the three-dimensional object. In this case, the divided parts can be joined with each other at a relatively natural position of the three-dimensional object, so that the joining portion of the divided parts can be prevented from being easily noticeable. When the joint of the rig is finely set, the cross-section including a relatively large joint may be determined as the dividing plane of the three-dimensional object.

What is claimed is:

1. A three-dimensional object configured by a plurality of divided parts and having a surface, one portion of the surface is covered with a covering member, the three-dimensional object comprising:
a first divided part as the divided part, at least one portion of the first divided part is exposed from the covering member; and
at least one second divided part as the divided part, covered with the covering member,
wherein at least one portion of a joining surface of the first divided part and the second divided part is covered with the covering member.

2. The three-dimensional object according to claim 1, wherein
entire of the joining surface is covered with the covering member.

3. The three-dimensional object according to claim 1, wherein
the first divided part is a 3D object of a face of a human,
the second divided part is a 3D object of a back of a head of the human, and
the covering member is wig.

4. The three-dimensional object according to claim 2, wherein
the first divided part is a 3D object of a face of a human,
the second divided part is a 3D object of a back of a head of the human, and
the covering member is wig.
